(19) United States
(12) Patent Application Publication
(10) Pub. No.: US 2012/0273008 A1
(43) Pub. Date: Nov. 1, 2012

(54) PIPELINE DECONTAMINATION PROCESS EMPLOYED IN THE OIL EXPLORATION AND PRODUCTION AND DECONTAMINATION SYSTEM USED TO PROCEED WITH THE DECONTAMINATION OF PIPELINES

(76) Inventor: Antonio Aparecido Brabo, Sao Paulo (BR)

(21) Appl. No.: 13/096,139

(22) Filed: Apr. 28, 2011

(51) Int. Cl. B08B 9/00

(52) U.S. Cl. 134/22.12; 134/169 C

(57) ABSTRACT

Pipeline decontamination process employed in the oil exploration and production and decontamination facility used to proceed with the decontamination of pipelines used in oil exploration and production, wherein a pipeline (T) to be decontaminated is submitted to a hydro-blasting phase for the purposes of removal of the material added to the internal wall of such pipeline. Such hydro-blasting process occurs in a closed circuit and where the water used for such process is submitted to filters for the retention of solid residues. Such hydro-blasting process is conducted in the presence of vacuum, which is used to promote the suction of residues removed, in conjunction with the volume of water used. The hydro-blasting process is taken into effect by employing a hydro-blasting spear (3) that is dislocated internally throughout the pipe (T) to be decontaminated.

### II. BACKGROUND OF THE INVENTION

1. Field of the Invention

This invention is for an innovative decontamination process of pipelines used in the operation of oil exploration and production processes. These processes are used to allow the use of such pipelines, after their decontamination from naturally occurring radioactive substances.

This invention is also related to the decontamination of the pipelines used, as described above, in oil exploration and production.

2. Description of the Related Art

As is already known by those in the oil industry, the processes of oil exploration and production requires the use of drilling equipment to bring the pumping equipment in contact with oil beds.

In exploration and production operations, the pipeline used comes in contact with various soil layers, thus being susceptible to crusting, for instance, by naturally occurring radioactive material, referred to as NORM (Naturally Occurring Radioactive Material) or TENORM (Technologically Enhanced Naturally Occurring Radioactive Material).

By definition and according to MORSE (1991), NORM is formed by the concentration of radioactive nuclides in certain materials, during various non-nuclear processes. The examples cited by the author are the emission of radium through coal ashes in thermoelectric power plants, radon in natural gas, radium in fertilizers with phosphogypsum, radium residues, thorium in processing plants of minerals containing rare soils and in determined oil prospecting processes, etc. When the radioactive nuclides associated with the natural materials arise after industrial processes take place, they are referred to as TENORM. In many times there is not a clear distinction between NORM and TENORM, with the term NORM being used in general to cover both. Thus, GRAY (1997) presents a definition for NORM that clearly includes technologically enhanced natural occurrence radioactive material, being given as “technologically enhanced naturally occurring radioactive material, including all radio nuclides whose physical, chemical, or radiological properties or concentration of radio nuclides has been changed from its natural state”. It is important to stress that one of the most common practices in offshore fields worldwide, such as those in a Brazilian installation called Campos Basin, is the injection of water in a treated seawater body (filtered, with bactericide and oxygen free) in the tank, in order to keep the pressure necessary for the production of oil and gas. The seawater injected is rich in sulfate ions (even though usually less saline than the formation water), and is in contact with barium, strontium, and radium ions that are present in the formation water, and precipitates of very low solubility are formed.

Changes of temperature, pressure, geochemical conditions, and flow-related changes experienced by such liquids in the productive process favor the deposition of such precipitates within the production columns and in the process plant, causing losses of production and the appearance of ionizing radiation levels above the natural levels.

The radio nuclides usually mobilized and present in the form of dregs, sandy material, and crusts are radium-226, radium-228 and lead-210, all from the naturally occurring radioactive series of uranium-238 and thorium-232, with the composition and specific activity of radio nuclides in the dregs, sandy material, and crusts found in the oil production vary in a great deal and depend on several factors.

The most recent publication by UNSCEAR (2000) mentions that: “Exposures due to natural sources of radiation, with a few exceptions, generally do not have the same level of control than exposures due to sources produced by man. The few exceptions are those of exposures in mines and plants of uranium, where purified forms of naturally occurring radioactive materials are handled, such as radium-226 and thorium. Even where the occupational control has already been introduced, the individual dosage data are very rare, with most of the data being available in the following years, as the result of evaluations carried out regarding if controlling measures should whether be introduced or not”.

Even though there is not sufficient data on occupational exposures to natural sources of radiation, various authors have shown their concern in relation to the radioactive crusts found in oil exploration facilities (TESTA et al., 1994, MILLER et al., 1991, WALDRAN, 1988, SMITH, 1987). Similarly, some companies express their concerns; however more relevance has been generally given to environmental and waste issues, (GRAY, 1997, GRAY, 1997 b, DUVALL, 1997) than to occupational aspects.

In Brazil, several studies have been carried out regarding occupational exposures to natural rational at oil exploration and production (E&P) installations, in spite of the number of workers being substantially high—approximately 20,000 workers involved with exploration and production in Campos Basin alone, distributed in 36 maritime units. Drums with oily dregs and steel pipes showed values of effective equivalent dose of up to 0.3 mSv/h (30 mR/h) and, even considering that only a fraction of these workers has any type of involvement with the crusts and dregs, it should be taken into account the large contingent of workers involved in the “E&P” activities, when compared with the practices in radioactive installations of the conventional industry, involving approximately 3,000 professionals in tasks related to the use of radiations.

It should also be taken into account that the Brazilian standards (CNEN-NE-6.02 and CNEN-NE-3.01), both by the National Commission of Nuclear Power, governing the use of ionizing radiation in the country, also are not clear about the licensing aspects or operation of installations with the appearance of this type of material.

In light of the observations presented above, it became necessary to define a safe solution method, without implying in risk to man and the environment.

### III. SUMMARY OF THE INVENTION

One of the objects of the present invention is to provide a process for the decontamination of pipelines used in the oil exploration and production operations.

It is another object of the present invention to provide such a decontamination process that is applied to pipelines that have acquired certain a crusting level with unsafe radioactive values.

Such pipelines, when reaching a maximum value of contamination, are obligatorily removed from site and stored in proper locations, receiving, upon treatment, care compatible with the respective capacity of causing harm to the welfare of individuals and to the environment.

In light of the problem described above, another object of this invention is to develop a safe decontamination process for pipelines used in oil exploration and production.

The decontamination process presented herein is based on a decontamination step that basically uses hydro-blasting for pipes having 3.5″, 4.5″, and 5.5″. Such hydro-blasting process applied to the pipes occurs concomitantly with the application of vacuum suction of the entire residual material, formed by water (from the hydro-blasting) and solid particulate in the form of dregs or similar.

The decontamination procedure proposed herein foresees that the residual material of the decontamination stage should be processed as to allow filtration, to then be separated from the liquid phase represented by the hydro-blasting water, with a substantial parcel of the water volume used returning to processing, while the solid material removed, after sieved, is brought to storage under the proper conditions.

This invention is for a decontamination process for pipelines of the typed employed in oil exploration and production, thus allowing that these pipelines can be retaken to use after being processed, thus avoiding the usual practice under which the pipelines, after achieving a limit value of contamination, are obligatorily removed from use and stored.

It is another object of this invention to provide such a method and apparatus or system that is practical and inexpensive to implement while retaining its effectiveness.

Further objects of the invention will be brought out in the following part of the specification, wherein detailed description is for the purpose of fully disclosing the invention without placing limitations thereon.

### IV. BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 illustrates an overview and schematic view of the flow chart of a decontamination in the present invention.

FIG. 2 illustrates a schematic view that shows the initial movement of the pipes to be submitted to the decontamination process, such movements occurring transversally over the decontamination equipment and beginning with the pipes in a standby position before the beginning of the process, where the pipes are kept in a part of the structure of the decontamination equipment specifically destined for this purpose.

FIG. 3 illustrates a sequential view to that shown in FIG. 2, where the first pipe comprising the set of pipes is in the standby position before the beginning of the process is released to be admitted in the longitudinal movement means that move and also support the pipes during the decontamination process per se.

FIG. 4 illustrates the movement of exit of the pipe already decontaminated and its conduction to the standby position after the decontamination.

FIG. 5 illustrates the already decontaminated pipe in its standby position.

FIG. 6 illustrates a schematic view that depicts the reception of the pipe to be submitted to the decontamination process, with such view also representing the moment also illustrated in FIG. 3.

FIG. 7 illustrates the longitudinal movement of the pipe to be submitted to the decontamination process proposed herein, with such view showing the dislocation of the pipe towards a fixed terminal of accommodation and collection of residues by vacuum.

FIG. 8 illustrates the stage following that shown in FIG. 7, where a mobile terminal of accommodation and collection of residues by vacuum is dislocated towards the end of the pipe to be decontaminated, considering that the same view also depicts the initial positioning of the hydro-blasting spear in relation to the fixed terminal of accommodation and collection of residues by vacuum.

FIG. 9 illustrates the condition in which the pipe to be submitted to the decontamination process is already duly positioned between the terminals (fixed and mobile) of accommodation and collection of residues by vacuum, with such view further illustrating the beginning of the dislocation of the hydro-blasting spear, conduced throughout the interior of the pipe to be decontaminated.

FIG. 10 illustrates the stage following that shown in FIG. 9, where the hydro-blasting spear has already traveled the entire length of the pipe to be decontaminated, to the point of surpassing its end, condition in which such spear will directly trigger a device that will detect the end of the decontamination stage.

FIG. 11 illustrates the return of the hydro-blasting spear.

FIG. 12 illustrates the movement of return of the mobile terminal of accommodation and collection of residues by vacuum.

FIG. 13 illustrates the longitudinal movement of return of the pipe already decontaminated.

FIG. 14 illustrates the position of the pipe already decontaminated and in the moment prior to its conduction to the part of the structure of the equipment where it is kept in standby position, stage shown in FIG. 3.

FIG. 15 illustrates a schematic view and an expanded scale view of the mobile terminal of accommodation and collection of residues by vacuum, such view showing the basic internal construction of such device.

FIG. 16 illustrates, schematically, the oil separator that, in conjunction with other equipment, defines the decontamination plant presented herein.

FIG. 17 illustrates the vacuum system employed in the decontamination installation presented herein.

### V. DETAILED DESCRIPTION OF THE EMBODIMENTS OF THE INVENTION

Specifically in relation to the decontamination apparatus and process subject of the present application includes hydro-blasting of pipelines.

In the process presented herein, the water used in the removal of the material added to the internal wall of the pipeline to be decontaminated is kept in a closed circuit. The decontamination being provided with filters for the retention of solid waste.

The same water is used in the entire process. Any loss of water is replenished as needed. After the pipes are cleaned, they will be monitored and certified in batches, and then taken to a few areas, where they are transported back to the facilities of the oil company, while solid waste generated from this process are duly stored and submitted to a specific area determined by the user.

To ensure the efficiency of the de-crusting of pipes “T”, it is necessary to observe the relevant processes that, once allied, will meet the national standards in force, by the National Commission for Nuclear Power, and the standards applicable to the SMS of the oil company, and based on such premises, the developed system operates in stages that are interconnected to meet these criteria.

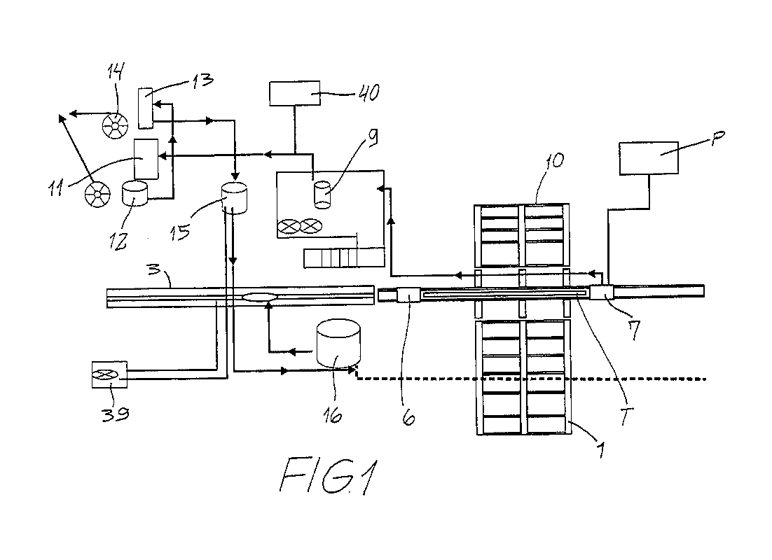

FIG. 1 illustrates a diagram of the decontamination installation presented herein, with such figure reproducing all stages of the process proposed herein, which includes the initial stage.

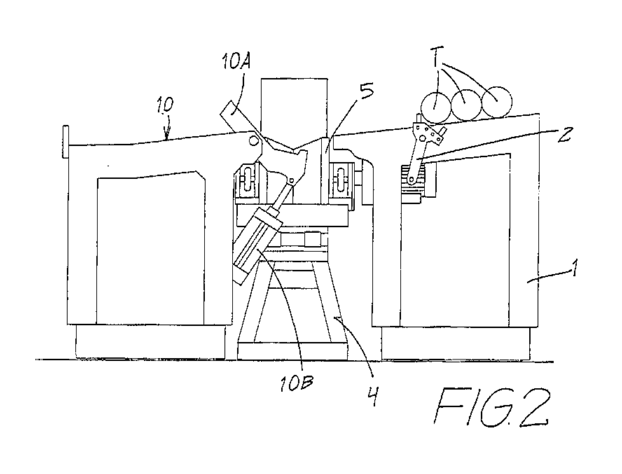

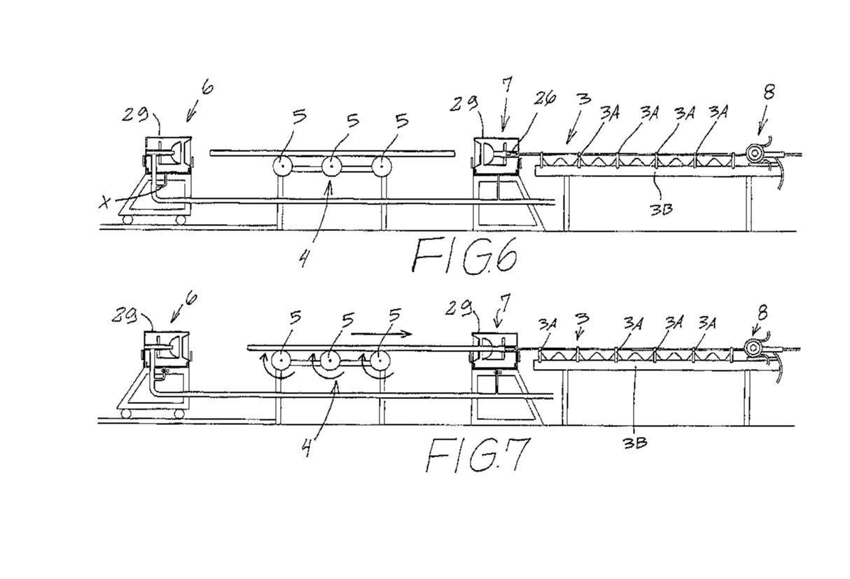

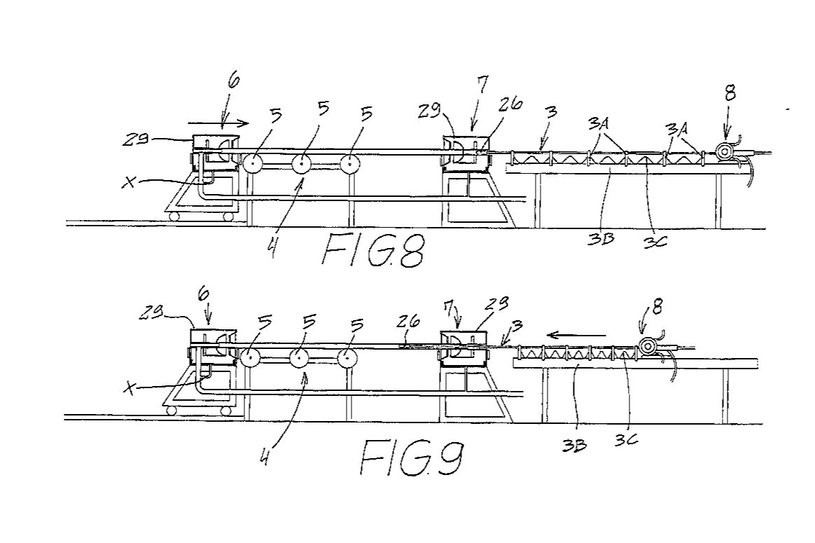

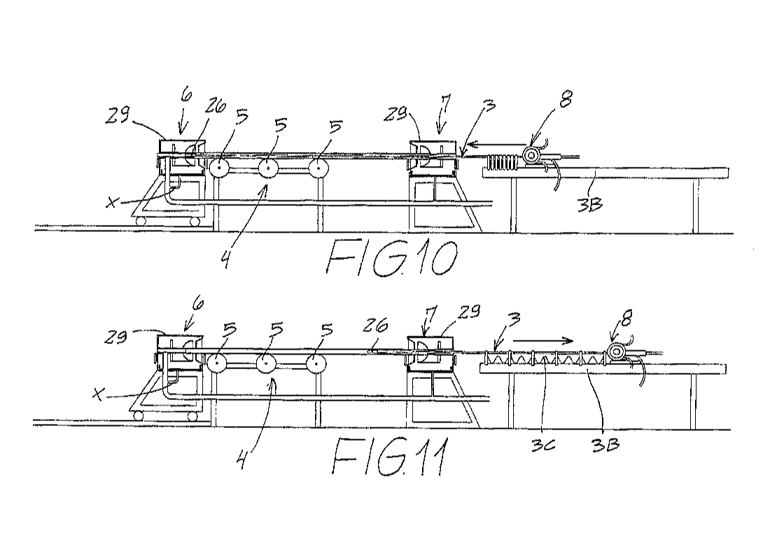

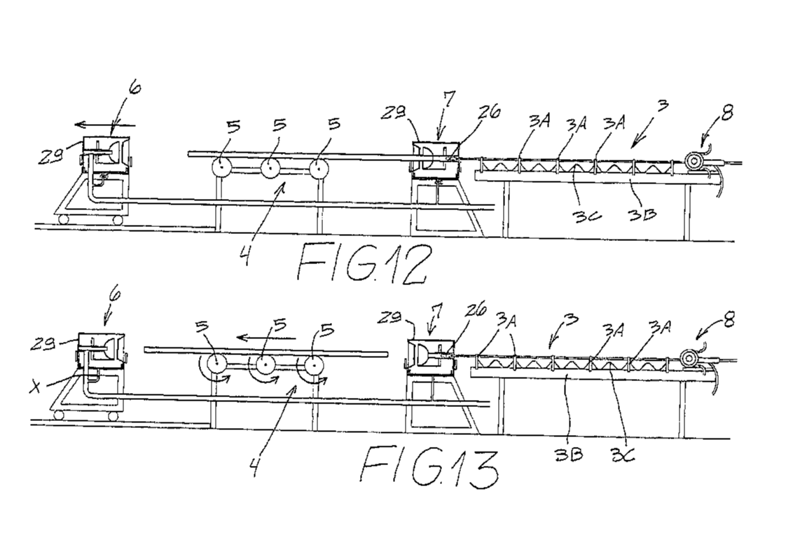

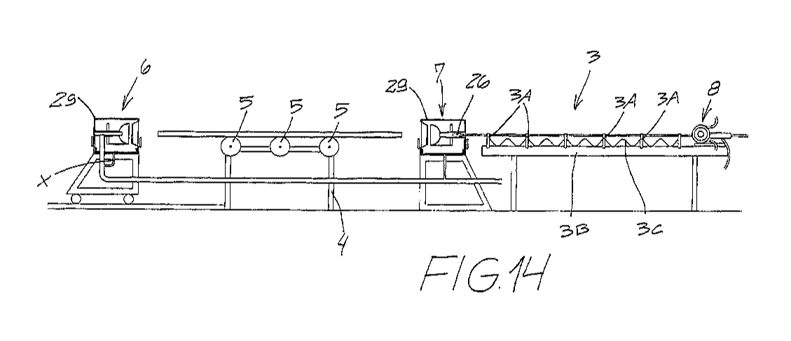

When pipes “T” arrive to the plant, pipes “T” are unloaded with a forklift and placed in cradles not illustrated, and then moved to a platform 1, where they are placed. Pipes “T” are moved individually to platform 1 through a device named mechanical trigger 2 (as best seen in FIG. 2), which will position each pipe “T” individually into the action line of the hydro-blasting spear 3, as best seen in FIGS. 6, 7, 8, 9, 10, 11, 12, 13 and 14.

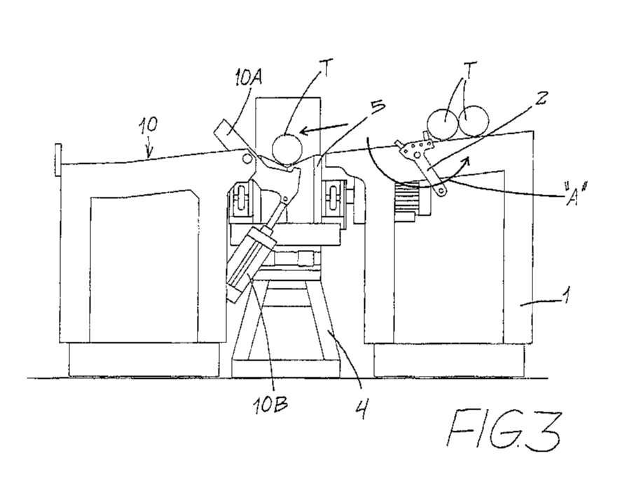

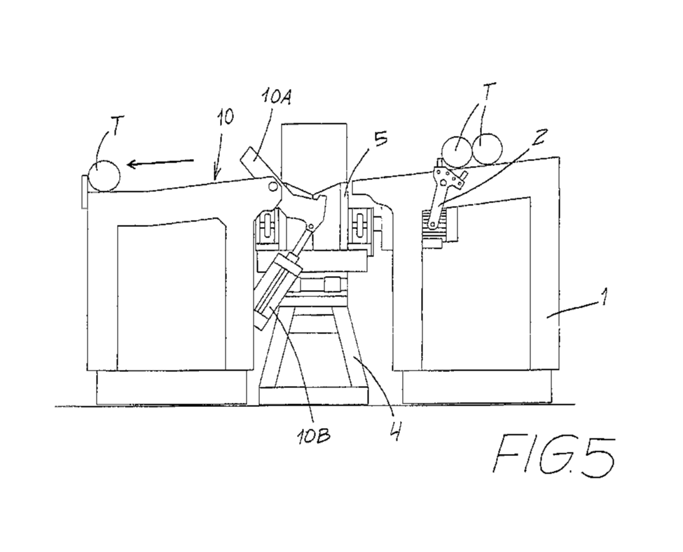

The mechanical triggering device 2, when activated, as shown in FIG. 3 and as indicated by arrow “A”, will allow the first pipe “T” placed on platform 1 to be carried to an easel 4, which relies on a set of support and movement rolls 5. Platform 1, as best shown in FIGS. 2 to 5, is inclined towards the levels where support and movement rolls 5 are located, thus facilitating the movement of such pipes “T” by allowing them to simply roll from a higher point to a lower point.

The following actions occur with pipe “T” positioned over such support and movement rolls 5:
a) Alignment of the terminals (mobile and fixed) of accommodation and collection of residues by vacuum, indicated by references 6 and 7, respectively, placed on both ends of pipe “T”, with such action preventing circulation water from deviation and environmental contamination.
b) Beginning of the hydro-blasting, where the hydro-blasting spear 3 is taken through pipe “T” by means of a pneumatic actuator 8, as shown in FIGS. 6 through 14. Such hydro-blasting spear is dislocated or out of place throughout the entire internal surface of pipe “T”, with hydro-blasting pressure pre-defined as to remove even the smallest deposited particle.

Concomitantly with the hydro-blasting operation, the vacuum system, as shown in FIG. 17, is activated to capture all the liquid effluent and transfer it to the first storage drum 9, preferably with a 1,000 liter capacity.

At the end of the course of action of hydro-blasting spear 3, pipe “T” is automatically removed to exit platform 10 and the whole process begins again to proceed with the decontamination of the following pipe “T”.

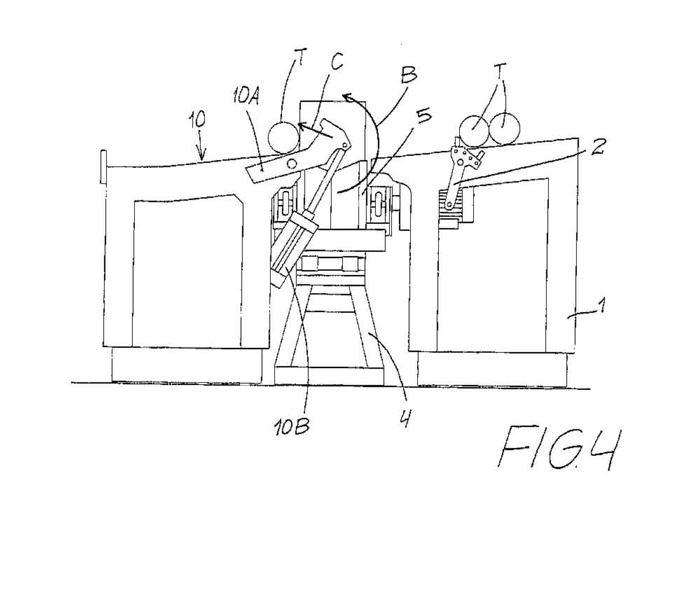

Exit platform 10 includes a movement lever 10A, which is triggered by an actuator 10B. Such movement lever 10A is placed below pipe “T” when over the support and movement rolls 5. Thus, when triggered by its actuator 10B (and as indicated by arrow B of FIG. 4), the movement lever 10A raises the pipe “T” over the rolls 5, directing such pipe “T” so that it can be dislocated, by simply rolling towards exit platform 10, as indicated by arrow “C” in FIG. 4.

Hydro-blasting spear 3 mounted over movable blocks 3A, which run over the base rail 3B, which is mounted over legs 3b, with the movable blocks 3A being interconnected by a cable 3C, which acts in the respective spacing of the movable blocks 3A as a result of the movement of hydro-blasting spear 3.

After placing the pipes onto exit platform 10, the pipes are then removed in batches of five units by a forklift, being then submitted to radiological monitoring for the evaluation of the de-crusting efficiency, and if there is not any radioactive material after this inspection, these pipes are placed into a cart and sent to the oil company.

All the liquid effluent and dregs, and eventually any oil captured by the vacuum system, are injected in a first sieve 11 by a pneumatic pump that perceives particles up to 15 mm, associated with drum 12, and placed below the discharge of the vacuum equipment. Such first sieve 11 serves to filter the macro-particles that will be deposited in a steel drum 12, preferably with a 200 liter capacity, and positioned at the beginning of the first sieve 11, with the filtered water following through the circuit until a second sieve 13.

Through a pump coupled to a drum 12, associated with the first sieve 11, the water from the first filtering stage is injected into the second sieve 13, which is intended to filter the micro-particles derived from the first sieving process. Such micro-particles are deposited into a steel drum 14, preferably with 200-liter capacity, and placed at the exit of sieve 13.

The water, which is totally free from radioactive particles, is deposited in a tank 15, preferably with a 1,000-liter capacity, and pumped into another tank 16, which preferably has a capacity of 10,000 liters, thus concluding the closed water circuit in the entire process.

The vacuum system, which can be seen in FIG. 17, has as objective to transport, by means of suction, the radioactive solution generated by the internal hydro-blasting of pipes “T” to the collection tank, not allowing solution aliquots to enter in contact with the environment. The solution to the mixture resulting from the internal hydro-blasting of the pipes has an approximate proportion of 140 liters of water to each 40 kg between iron oxide and barium sulfate, and some parcel of oil. This solution is generated in approximately 2 minutes of operation.

A system composed by the vacuum pump 17, separation cyclone 18 with deposit, pneumatic drawer valve 19 (discharge), in-line safety filtering system 20 and pipelines, promotes the operation as described below.

The suction (vacuum) causes the removal of the solution generated from the cleaning of pipes “T” through pipelines to separation cyclone 18, which has a lower deposit with a pneumatic drawer valve 19 that releases the solution in a collection tank 21.

Following this step (upper exit of the cyclone), a pipeline 22 is interconnected with the sleeve filtering system 23, which also relies on a lower discharge valve 24, allows the passage of the solution to the same collection tank 21.

The upper exit of the filter system is interconnected, through a pipeline 25, to the inline safety filter 20, which, in turn, through pipelines, is interconnected to the vacuum pump, Roots type 17.

The hydro-blasting system, in turn, is intended to promote the internal de-crusting of the pipes “T” through the employment of high-pressure water blast.

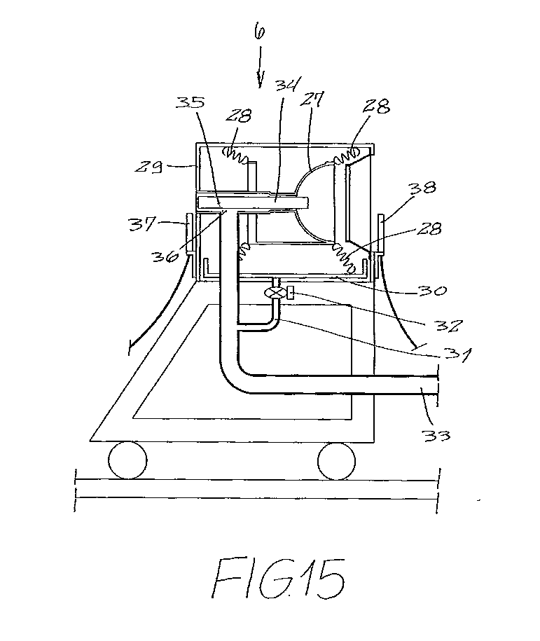

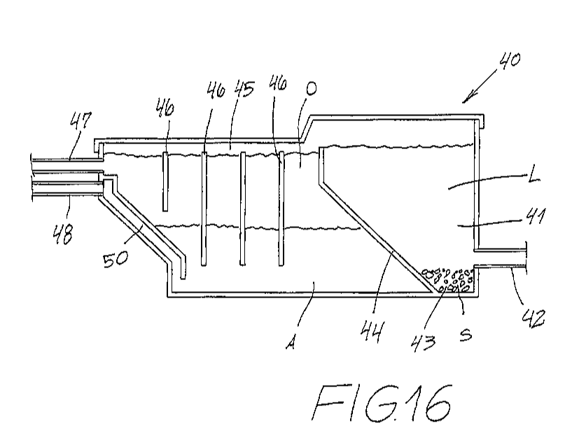

The hydro-blasting system, as previously mentioned, is composed by the hydro-blasting spear 3, provided by the hydro-blasting head 26. The hydro-blasting system further comprises the previously mentioned mobile and fixed terminals of accommodation and collection of residues, indicated by references 6 and 7, respectively, which also count on boot plugs for suction 27 connected to the vacuum system. As seen in FIG. 15, which in spite of presenting the mobile terminal of accommodation and collection of residues by vacuum action 6, it presents the same basic solution of the fixed terminal of accommodation and collection of residues by vacuum action 7. This is provided with an assembly with springs 28 that support and stabilize the boot 27 within a case 29, with such case 29 being provided with an internal platter 30. This captures eventual remainders of water and residues escaping from the boot 27.

The internal platter 30 relies on its own pipeline 31, which includes a valve activated by solenoid 32 that connects such internal platter 30 with the main pipeline 33, which applies the vacuum in such mobile terminal of accommodation and collection of residues by vacuum action 6. The same also occurs with the fixed terminal of accommodation and collection of residues by vacuum action 7.

A central nucleus 34 is mounted in boot 27, in a manner that is likely to be touched by the head 26 of the hydro-blasting spear 3 when it arrives at the end of its course.

Such central nucleus 34 presents a stem 35 that crosses the axial pipeline 36 of such boot 27. Such stem 35 emerges from the opposite side of case 29, where it can be perceived by a sensor 37 that detects the condition of end of course of hydro-blasting spear 3.

As evidenced, this installation includes the previously mentioned boot plugs 27, proximity sensors 37, and limit sensors 38, as well as easels and platforms for moving and arranging cargo, selecting a system of pipes in the format of trigger, compressors 39 (high pressure pump with 175 HP electric motor), 300-liter tank for water demand, pneumatic retractile bases for advance and collection of the hydro-blasting spear 3, and programmable assisted slave electric panel with cabling to 20 meters of distance from the hydro-blast base, indicated by reference P in FIG. 1.

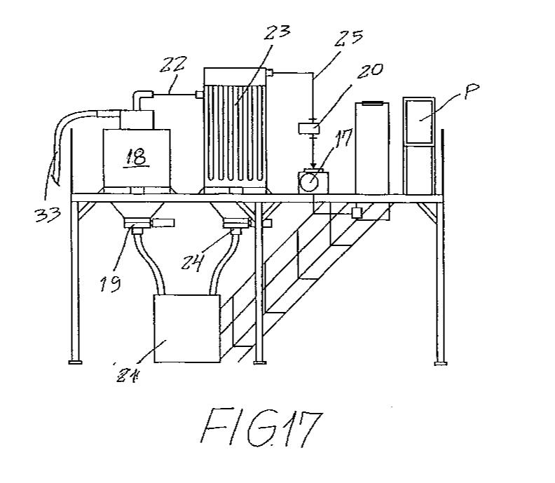

The installation treated herein also includes an oil separator, 40, which is retreated in particular in FIG. 16.

Oil separator 40 receives the water from hydro-blasting and promotes its separation in three basic phases, being represented as: water per se, residual solid material, and oil eventually present in the material removed from the pipes “T”.

Oil separator 40 comprises an intake compartment 41, where the flow of water/residual solid material and oil is admitted through the intake pipeline 42. First compartment 41 presents a lower portion 43 that is frontally delimited by an inclined wall 44, with such lower portion 43 being ready to receive and accumulate the heavier material present in the liquid phase, i.e., the portion of residual solid material, indicated by reference “S”. The remainder of the liquid phase (indicated with “L”), is formed by water and, eventually, any parcel of oil that is directed, due to overflow, to a second compartment 45.

Liquid phase “L”, formed by water “A” and eventually any oil “O” parcel that is transferred to the second compartment 45, is contained in its interior, where the vertical plates 46 are located, which are intended to avoid the formation of waves or any turbulence in the interior of the second compartment 45.

The liquid phase, when accumulated in the second compartment 45, tends to be separated in a first phase, which is water “A” per se, and the second phase, oil “O”. Since water is naturally denser, it occupies the lower portion of second compartment 45, while the oil indicated by reference “O”, which is less dense, tends to occupy the upper part of such second compartment 45.

At the correct moment, oil “O” can flow through upper exit 47 existing at the structure of oil separator 40, while water “A” can be drained through lower exit 48, which is connected to an internal channel 50 that has its collection point next to the lowest part of second compartment 45.

The water processed in the oil separator 40 returns to the decontamination system, while the solid residual material “S” is periodically received and discarded as contaminant materials, as verified by the material removed directly by hydro-blasting.

Oil “O” is also collected and properly treated within the philosophy of work of the decontamination plant presented herein.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. Decontamination process of pipelines used in oil exploration and production, wherein the pipeline (T) to be decontaminated is submitted to a hydro-blasting stage for the purposes of removal of the material added to the internal wall of such pipeline, such hydro-blasting process occurring in a closed circuit in which the water used is submitted to filters for the retention of solid residues, such hydro-blasting process being conducted by vacuum, which is used to promote the suction of removed residues, in conjunction with the water volume used; the hydro-blasting process is provided with the employment of a hydro-blasting spear (3) that is dislocated internally throughout the pipe (T) to be decontaminated.

2. Decontamination process of pipelines used in oil exploration and production, according to claim 1, wherein after the cleaning of pipes (T), these are monitored and certified in batches, being duly arranged for new usage, considering that the monitoring taken into effect is of radiological origin for the evaluation of the de-crusting efficiency.

3. Decontamination process of pipelines used in oil exploration and production, according to claim 1, wherein the solid waste generated by the hydro-blasting of the pipes (T) are duly packaged and submitted for due storage.

4. Decontamination installation used to proceed with the decontamination of pipelines used in oil exploration and production, used to proceed with the decontamination process treated in claim 1, wherein contains a platform (1), where the pipes (T) are arranged in the beginning of the decontamination process, such structure of platform (1) counts relies on a device named mechanical trigger (2), which will position, with its movement, a pipe (T) per time in the action line of a hydro-blasting spear (3) provided with a hydro-blasting head (26); the mechanical triggering device (2), when activated, allows that the first pipe (T) arranged onto the platform (1) is conducted to an easel (4), which counts relies on a set of support and movement rollers (5), with the platform (1) presenting an inclination towards the level where the support and movement rollers (5) are located; the installation counts relies on mobile (6) and fixed (7) terminals of accommodation and captivation collection of residues by vacuum, which are placed at both ends of the pipe (T), considering that such action avoids circulating water from deviating and contaminating the environment; a hydro-blasting spear (3) is foreseen, even though it is triggered by movement means defined as a pneumatic actuator (8), as it is dislocated internally throughout the pipe (T); a vacuum system is foreseen to captivate the material resulting from the hydro-blasting process, such vacuum system counting on a first storage drum (9), preferably dimensioned for a capacity of 1,000 liters and to where the residues are initially destined; existence of an exit platform (10) to where each pipe (T) already decontaminated is submitted, such exit platform (10) counting on a movement lever (10A) activated by an actuator (10B), such movement lever (10A) being arranged on a lower level than that occupied by the pipe (T) when the pipe (T) is over the support and movement rollers (5), in a manner that when activated by its actuator (10B), the movement lever (10A) raises the pipe (T) that is over the rollers (5), dislocating such pipe (T), by simply rolling, to the exit platform (10).

5. Decontamination installation used to proceed with the decontamination of pipelines used in oil exploration and production, according to claim 4, wherein the hydro-blasting spear (3) is mounted onto movable blocks (3A) that run over a basis rail (3B) that is mounted over legs, considering that the movable blocks (3A) are interconnected by a cable (3C), which acts in the correct spacing of the movable blocks (3A) as a result of the movement of the hydro-blasting spear (3).

6. Decontamination installation used to proceed with the decontamination of pipelines used in oil exploration and production, according to claim 4, wherein the installation relies on a first sieve (11), responsible for sieving the effluent produced by the hydro-blasting process and that is submitted thereto by means of a pneumatic pump that perceives particles up to 15 mm, associated to a drum (12) placed right below the vacuum equipment, considering that this first sieve (11) is intended to filter the macro-particles to be deposited into a drum (12), preferably with 200 liters and positioned at the exit of the first sieve (11).

7. Decontamination installation used to proceed with the decontamination of pipelines used in oil exploration and production, as of claims 4 and 6, wherein after the first sieve (11), there is a second sieve (13) that receives the filtered water from the first sieve (11), considering that through a pump coupled to the drum (12) associated with the first sieve (11), the water from the first filtering stage is injected in the second sieve (13), which is intended to filter the micro particle derived from the first sieving process, considering that such micro particles are deposited in a drum (14), preferably with 200 liters of capacity and positioned in the exit of such second sieve (13); a tank (15) receives the water totally free from the radioactive particles, such tank preferably having capacity of 1,000 liters; the water contained in the tank (15) is pumped from the first to the other tank, indicated by numerical reference (16), preferably having a capacity of 10,000 liters, thus concluding the closed water circuit in the entire process presented in this installation.

8. Decontamination installation used to proceed with the decontamination of pipelines used in oil exploration and production, as of claim 4, wherein the vacuum system is intended to transport, by means of suction, the radioactive solution generated by the internal hydro-blasting of the pipes (T) until the collection tank, not allowing that solution aliquots enter in contact with the environment, such vacuum system being composed by a vacuum pump (17), separation cyclone (18) with deposit, pneumatic drawer valve (19) of discharge, inline safety filtering system (20), and pipelines; the separation cyclone (18) relies on a lower deposit that is provided with such pneumatic drawer valve (19) that offloads the solution in a collection tank (21); the separation cyclone (18) relies on an upper exit, which, through a pipeline (22), is interconnected with the filtering system with sleeve filters (23), also counting on a lower discharge valve (24), which allows the passage of the solution to the same (21); the upper exit of the filtering system is interconnected, by a pipeline (25), with the inline safety filter (20) which, on its turn, through pipelines, is interconnected with the vacuum pump, Roots type (17).

9. Decontamination installation used to proceed with the decontamination of pipelines used in oil exploration and production, as of claim 4, wherein the mobile (6) and fixed (7) terminals of accommodation and collection of residues count on suction plugs (27) connected with the vacuum system; specifically in relation to the mobile terminal (6), there is an assembly with springs (28) that support and stabilize the plug (27) inside a case (29), such case (29) counting on an internal platter (30) that captures eventual remainders of water and residues escaping from the plug (27); the internal platter (30) relies on its own pipeline (31), provided with valve activated by solenoid (32) that communicates such internal platter (30) with the main pipeline (33), which applies the vacuum to such mobile terminal of accommodation and collection of residues by vacuum (6), the same also occurring in the fixed terminal of accommodation and collection of residues by vacuum (7); a central nucleus (34) is mounted to the plug (27) of the terminal (6) in a manner that is likely to be touched by the head (26) of the hydro-blasting spear (3) when it arrives its course end; such central nucleus (34) presents a stem (35) that crosses the axial pipeline (36) of such plug (27), such stem (35) emerging by the side opposed to that of the case (29), where it can be perceived by a sensor (37) that detects the condition of end of course of the hydro-blasting spear (3); there are also limit sensors (38).

10. Decontamination installation used to proceed with the decontamination of pipelines used in oil exploration and production, according to claim 4, wherein the installation relies on an oil separator (40), which receives water from the hydro-blasting and promotes its separation into three basic phases, represented by: water per se, residual solid material, and oil eventually present in the material removed from the pipes (T); the oil separator (40) consists of an intake compartment (41), where the flow of water/residual solid material and oil is admitted through the intake pipeline (42); the first compartment (41) presents a lower part (43) that is frontally delimited by an inclined wall (44), such lower part (43) being destined to receive and accumulate the heaviest material present in the liquid phase, which is the portion of residual solid material, indicated by reference (S), with the remainder of the liquid phase (L) being formed by water and eventually some part of oil being directed, by overflow, to a second compartment (45); the liquid phase (L) formed by water (A) and eventually a part of oil (O) is transferred to the second compartment (45) being contained in its interior, where vertical plates (46) are located, which are intended to avoid the formation of waves or any turbulence inside the second compartment (45); the liquid phase, when accumulated in the second compartment (45), tends to be separated in a first phase, which is water (A) per se, and the second phase being oil (O), and considering that since water is naturally denser, it occupies the lower part of the second compartment (45), while the oil indicated by reference (O), for it is less dense, tends to occupy the upper part of such second compartment (45); in the due moment, the oil (O) can be flowed through an upper exit (47) provided in the structure of the oil separator (40), while water (A) can be drained through the lower exit (48), which is connected to an internal channel (50) that has its collection point next to the lowest part of the second compartment (45).

11. Decontamination installation used to proceed with the decontamination of pipelines used in oil exploration and production, according to claim 4, wherein the water processed in the oil separator (40) returns to the decontamination system.
